(19) United States
(12) Patent Application Publication
(10) Pub. No.: US 2004/0240975 A1
(43) Pub. Date: Dec. 2, 2004

(54) Packaging machine

(75) Inventor: Bruno Baraggioli, Buenos Aires (AR)

Correspondence Address: Norris, McLaughlin & Marcus P.A., 30 Floor, 220 East 42nd Street, New York, NY, 10017, US

(73) Assignee: Manuli Packaging Argentina S.A., Buenos Aires (AR)

(21) Appl. No.: 10/809,557

(22) Filed: Mar. 25, 2004

(30) Foreign Application Priority Data
Mar. 27, 2003 (AR) P 030101076

(51) Int. Cl. B60P 1/02

(52) U.S. Cl. 414/495

(57) ABSTRACT

Packaging machine, used to pack with several turns of laminal material objects piled up on a platform, until conforming a package or “pallet” firmly wrapped to be afterward elevated by means of a freight elevator and to be transferred to another location, for example, towards a deposit for its storage or to load them in vehicles destined to transport them to another destiny, including said cart a chassis with elevating members where a roll or coil of laminal material is mounted in supporting connection on a support device, where the elevating members of the coil of laminal material are defined by a type-scissors mechanism, in one of whose superior arms is mounted in supporting connection said material coil carry support device, including the cart an operation control electronic unit that allows to controlling the machine remotely.

The machine is defined by a self-propelled cart mounted in a sliding way on an annular rail that delimits a circular surface where the platform with the objects to be packed is located. The cart presents a chassis where a type scissors mechanism is mounted, being said mechanism formed by a plurality of articulated to each other arms, in whose upper arm end portion the laminal material roll or coil, which extends raising and lowering the laminal material during the packaging or “palletizing” process. The propulsion is obtained by means of a traction motor to which a traction wheel is connected, whereas the ascending and descendent movement of the scissors type mechanism is driven by a motor which an endless screw connected to one of the lower arms of the scissors type mechanism. Reloadable batteries are arranged in the chassis of the cart to provide power supply to both motors and to an electronic operation control unit on of the machine, remotely commanded and wireless form, arranged in the chassis of the cart. The machine includes sensors that detect the upper end portion of the pallet, the presence of strange objects in the surface delimited by the annular rail and sensors that allow the machine to always stop in a same point of the rail when finishing a packaging cycle.

### BACKGROUND OF THE INVENTION

1. Field of the Invention

This invention relates to a packaging machine and, more particularly, is related to a machine habitually denominated in the industry as “pallet making machine”, which is destined to wrap up or to pack a certain amount of objects of diverse nature which are generally piled up on a platform or stand, to be afterward elevated by means of a freight elevator and to be transferred to another location, for example, towards a deposit for its storage or to load them in vehicles destined to transport them to another destiny. Concretely, the machine of the present invention is of the used type to wrap up objects piled up on a platform with plastic material sheets so as to surround them with several turns of said sheets until forming a firmly wrapped up package.

2. Description of the Prior Art

Diverse machines of the type previously mentioned are known in the prior art; among said machines it is possible to mention two of the most used ones at the present time. In effect, a first type of packaging machine is conformed by a vertical column fixed to the end of a base and throughout which a support, that carries a roll (or coil) of the plastic sheet, moves in descendent ascending direction, while on the this base a generally circular revolving table is arranged to certain distance of the column. In order to make the packaging, or “palletizing”, once the platform is arranged on the revolving table and the objects to be packed are piled up on it, and after fixing an end portion of the sheet, for example in some point of the platform, mechanisms associated to this table are driven so as it begins turning. While table turns, and according to a predetermined operation sequence, the coil-carry support connected to the column begins to ascend and to descend progressively until forming the package with the required firmness, after which the revolving movement of the platform stops, cuts the plastic film and concludes therefore the packaging process.

Other packaging machine that is useful to mention like previous art in the subject, includes a fixed main vertical column from whose superior end a horizontal fixed arm projects to which is movably engaged a movable horizontal arm and, in its end portion, a movable vertical column is positioned, throughout a complex sheet material coil carry support mechanism moves. Unlike the machine previously described, with this packaging machine the platform with the piled up objects simply is supported in the floor and the envelope is made when turning the mobile column around the platform, rising and descending the coil carry support mechanism in analogous form to already explain in relation to the other machine until concluding the packaging.

Although these machines are widely used at the present time and enjoy the great prestige in the market, because of their structural characteristics present certain disadvantages and problems that are opportune to solve. In effect, these machines have a great size and weight, reasons why preferably they must be installed in an anticipated fixed place for its practically definitive installation; they are not easily transportable in case it would be necessary; since they generally require three-phase electrical energy, the place where they settle must have this type of energy, which is not always possible or simple to solve in immediately and, in addition, they consume an important amount of electrical energy.

In the particular case of the first mentioned machine, it is possible to also indicate between the disadvantages and problems of their use the fact that when turning the circular platform with the platform loaded with piled up objects, this movement causes certain instability of the objects, specially if those objects are bottles or articles whose geometry, volume and weight do not help or make difficult to pile them up. In addition, its general structure is mechanically very complex, as thus also it is the transmission of electrical energy to drive the movable parts and its joints, for example, it is evidenced by the electrical technical problems that appear in the collectors with coals. Observating disadvantages of machines of prior art and according to what has been shortly explained therebefore and necessity to solve them efficiently, the packaging machine of present invention was developed, which, as it will be seen clearly when describing it with the help of the figures that illustrate it, further solving such disadvantages it offers remarkable additional advantages.

In effect, the machine of the present invention allows a very versatile use; its operation does not depend on the electrical energy available in the place where it will be installed and, moreover, it does not require network energy; they are lighter and smaller than those known machines, reason why transporting it is very easy, thus allowing to load several machines in a same vehicle. Manufacturing, installation and maintenance are much more economic respect the well-known machines costs because materials and components used in the machine of the present invention are generally available in the market because they are frequently used in diverse industries, specially referring to mechanical, electrical as well as electromechanical components.

### SUMMARY OF THE INVENTION

It is therefore an object of the present invention to provide a packaging machine, of the type that comprises a self-propelled cart that turns around a set of objects of diverse nature piled up on a platform in order to wrap them up with some laminal material, generally plastic film, surrounding them with several turns of laminal material until conforming a package firmly wrapped up which will be later elevated by means of a freight elevator in order to be transferred, for example, towards a deposit for storage or to load it in vehicles destined to transport it towards another destiny, including said cart a chassis elevating members where a roll or coil of laminal material is mounted in supporting connection on a support device, where the elevating members of the coil of laminal material are defined by a type-scissors mechanism, in one of whose superior arms is mounted in supporting connection said material coil carry support device, including the cart an operation control electronic unit that allows to controlling the machine remotely.

### BRIEF DESCRIPTION OF DRAWINGS

For better understanding and clarity of the object of the present invention, it has been illustrated in several figures, in which it has been represented in the preferred forms of accomplishment, everything for a reason or purpose of example, wherein:

FIG. 1 is a front view in perspective of the machine in agreement with the present invention, where a cart is shown on a rail on which it moves being its elevating members partially expanded, as one of the positions that it assumes during operation.

FIG. 2 is a partial front view in perspective of the machine shown in FIG. 1, in this case mechanisms mounted on a chassis are shown in detail.

FIG. 3 is further front view in perspective of the machine shown in FIG. 1, in this case elevating members folded in a lower or initial position from where the cycle of operation of the machine begins are shown.

FIG. 4 is a rear view in perspective of the machine of the present invention, wherein the sheet material coil elevating members are partially spread out.

FIG. 5 is a schematic view taken above the cart of the machine of the present invention, wherein an inductive sensor of cart stop and a strip of metal in operative connection with said sensor and arranged in the rail on which the cart moves.

FIG. 6 is a plant view that schematically represents the general disposition of the machine of the present invention during a packaging operation of a set of objects arranged on a platform.

FIG. 7 is a schematic view of the frontal panel of a control unit used in the machine of the present invention.

### DESCRIPTION OF THE PREFERRED EMBODIMENTS

With the purpose of simplifying the following explanation, when it will be considerated opportune the terms “pallet” and words derived from this, such as “to palletize” and “palletized” will be used referring to “platform-objects” set and packaging operations.

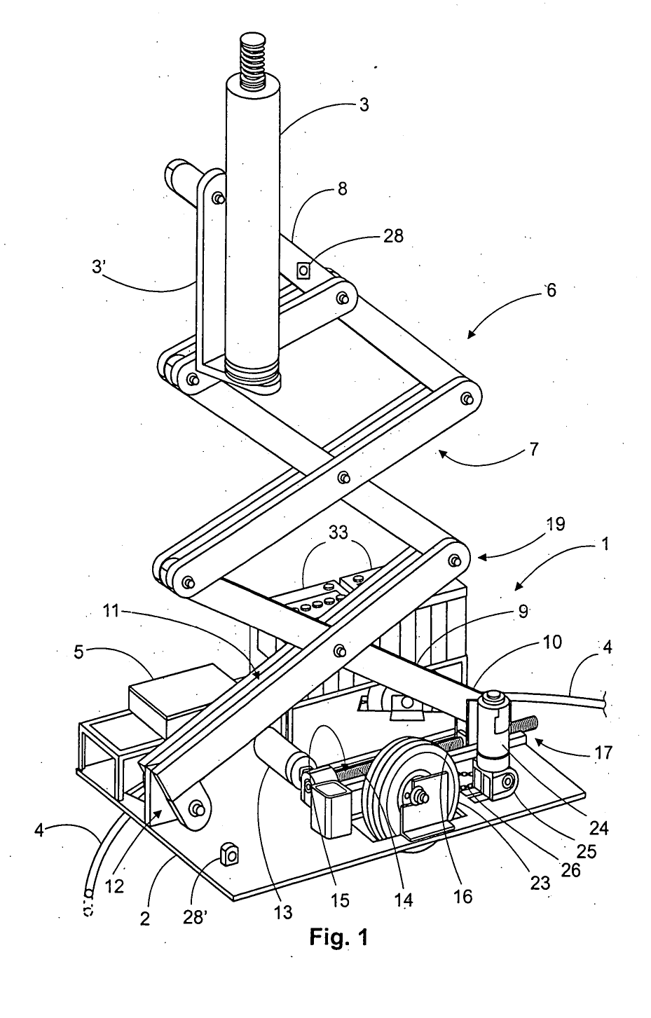

Referring now to FIGS. 1-3, it can be noticed that this packaging machine, or “palletizer”, includes a self-propelled cart 1 that presents a chassis 2 which carries the elevating members of the laminal material coil 3, being said cart 1 mounted on an annular rail 4 which delimits a circular surface in whose centre the platform is located on which the objects to be to packed or “palletized” with the laminal material are piled up. To enable the cart movement on rail 4, propulsion devices are arranged in chassis 2, said propulsion devices will be defined afterwards. Cart 1 general operation, so as its displacement on rail 4 as driving said elevating members, is carried out through a remotely commanded electronic control unit 5 from a control panel (not illustrated).

Elevating members comprise a type-scissors mechanism 6 formed by a plurality of arms articulated generally indicated 7, being fixed to a superior arm 8 a support device 3′ which carries a coil 3 of laminal material. A first inferior arm 9 of the scissors mechanism 7 is movably connected at its end portion 10 to the ascending-descending movement drive devices, whereas a second inferior arm 11 is movably connected at its end portion 12 to chassis 2.

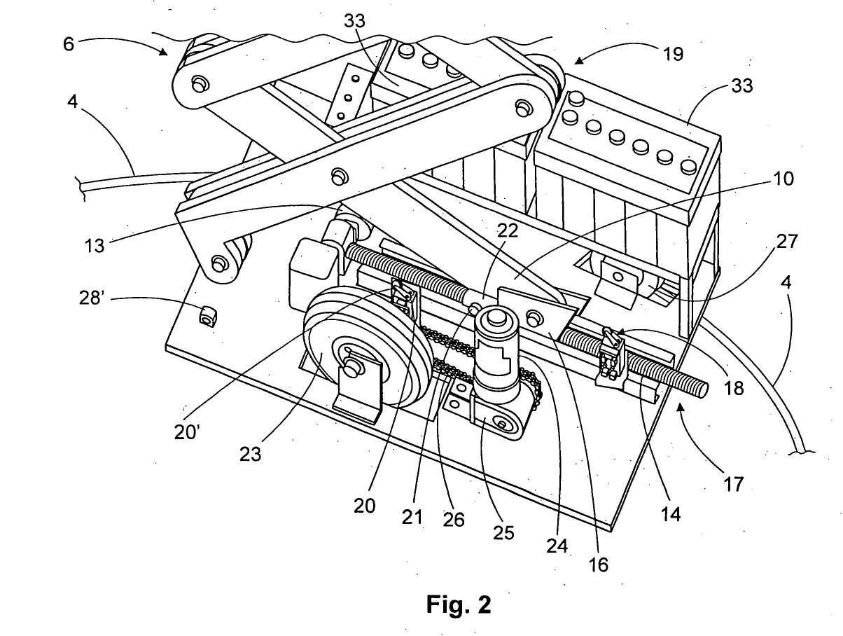

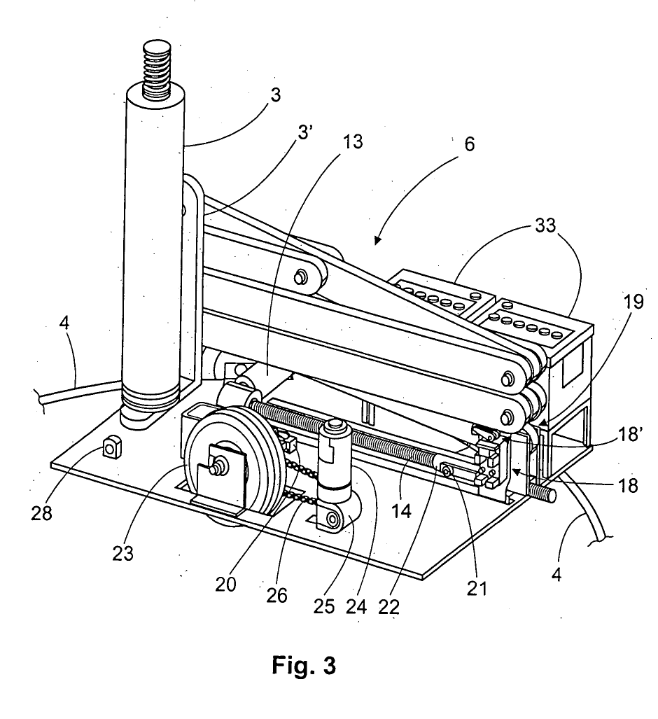

Type scissors mechanism's ascending-descending movement drive devices are defined by a motor 13 and a endless screw 14, that extends parallely to the chassis 2, and which that presents a first end portion 15 connected to motor 13, passing said this endless screw 14 through a screwed dice 16 fixed to the lower end portion 10 of the lower arm 9 of the scissors type mechanism 6. A lower end-track switch 18 (see FIG. 2), proximate to a second end portion 17 of the endless screw 14, is arranged on chassis 2, which is operatively connected with motor 13 for operating scissors mechanism 6. It is also observed, specially in the FIG. 3, that the lower end-track switch 18 is aligned below a second end portion 19 of lower arm 11 of the scissors type mechanism 6. Thereby, when scissors type mechanism 6 folds, the end-track switch 18 detects the presence of the inferior arm 19 that acts on lever 18′, and turns off motor 13 until as much control unit 5 actuate to allow the activation of said motor 13 in order to elevating scissors mechanism 6.

Furthermore, near motor 13 an upper end-track switch 20 (see FIGS. 2 and 3) is arranged on chassis 2, said switch is also operatively connected to motor 13. The end-track switch 20 is activated and deactivated by means of wheel 21 a mounted in a fixed tube 22 fixed to screwed dice 16, throughout which also endless screw 14 goes through. This way, when scissors mechanism rises 6, when the endless screw 14 turns in the corresponding direction, end portion 10 of inferior arm 9 moves and therefore comes closer wheel 21 until it drives lever of the end-track switch 20, which interrupts motor 13 energy supply, thus stopping the ascending movement of the scissors type mechanism 6 until control unit 5 turns it on again, but in opposed rotation direction, in order to start the descending movement of the scissors type mechanism 6, completing therefore the machine operating cycle. However, it is possible to indicate said upper end-track switch 20 actually is optional, because detecting that the upper end portion of the pallet has been reached is specially in charge of an optical sensor, generally indicated by numeral 28, as will be explained later.

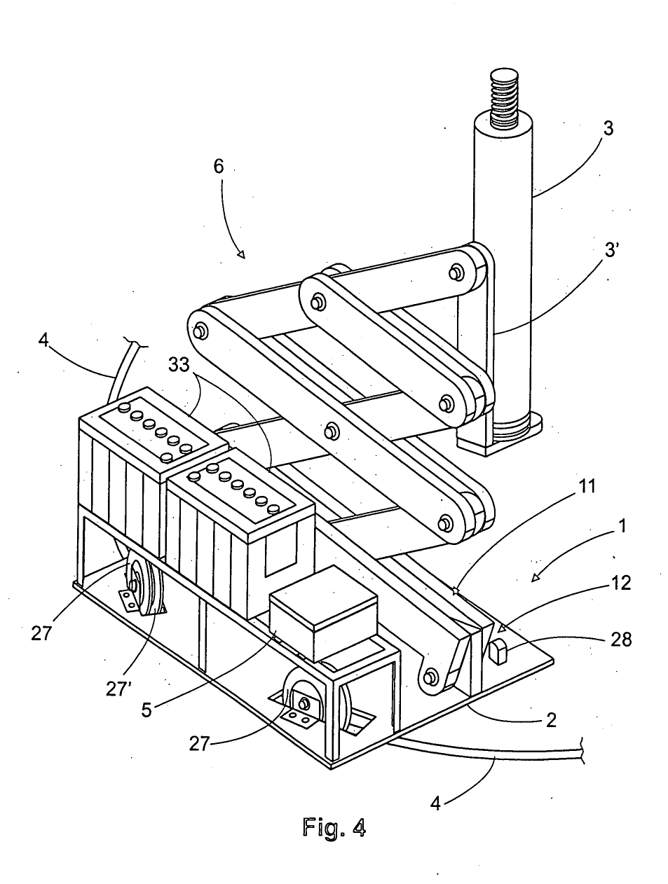

In order to displacing cart 1 on rail 4, a drive wheel 23 is placed on chassis 2, said wheel 23 is supported on the floor of the place of operation of the machine and is engaged to a drive motor 24, and more concretely to a reducer of speed 25, through a transmission chain 26. Otherwise, with the same purpose, as clearly can be seen in FIG. 4, a pair of wheel 27 are arranged in chassis 2 for the assembly and displacement of the cart 1 on the rail 4. As can be seen, wheels 27 present a central perimetral slot 27′ where rail 4 snaps. Starting and stopping operations of motor 24 are commanded by the control unit 5, which, in addition, is operatively associated to security sensors of security and to cart stopping sensors, according to what will be explained later.

In a superior end of the scissors type mechanism 6, more concretely in upper arm 8 and the proximities of laminal material coil 3, an optical sensor 28 is arranged to detect that it has been reached the upper end or top of the set of objects piled up on the corresponding platform to be packaged. Said optical sensor 28 is also functionally associated to control unit 5, wherein the corresponding signals are processed and are commanded the starting and stopping of motor 13.

In order to avoid possible accidents or errors in the operation of the machine before the illegal or unexpected presence of strange objects or people on the area delimited by the annular rail 4, in chassis 2 an security optical sensor 28′, that when sending the signal corresponding to the control unit 5, allows to immediately deactivate and stop motors 13 and 24, stopping therefore the displacement of the cart 1 like thus also the ascending or descendent movement of the scissors type mechanism 6.

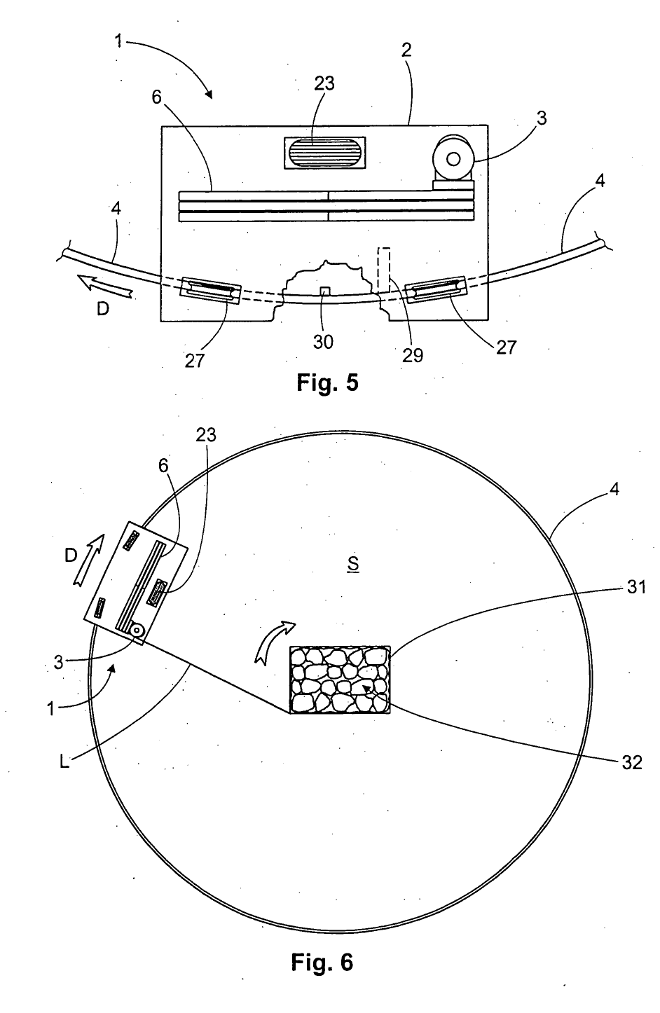

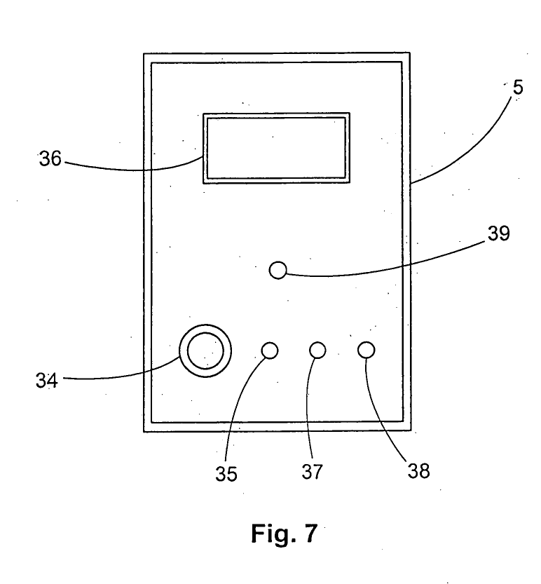

As schematically shown in FIG. 5, below chassis 2 there is a cart stopping sensor 29 in a predetermined point of rail 4, in order to the operation cycle of the machine always initiates and finalizes in a same point of this rail 4. Sensor 29 is an inductive sensor and is operative associated with a ferromagnetic strip of metal 30 arranged in rail 4. This way, when cart 1 advances on rail 4 in the displacement direction indicated with the arrow “D”, when sensor 29 places over strip of metal 30, a signal is sent to the control unit 5 that processes it and orders the immediate stop of the drive motor 24, stopping cart 1 on rail 4 in that location.

It is possible to indicate that rail 4 is conformed by sections connectable to each other and in agreement with the unions of these sections access ramps can be arranged for freight elevators to the area delimited by rail 4. In this case, strip of metal 30 can be arranged, for example, in the portion of the ramp that extends towards the surface surrounded by rail 4.

In schematic representation of FIG. 6 a surface “S” delimited by rail 4, mounted cart 1 on this, a plurality of pallets 31 loaded with objects 32 to be palletized located in the centre of said surface “S” and laminal material “L” as it extends from cart 1 towards pallet 31 during the palletizing operation, being indicated by means of arrow “D” the direction of displacement of said cart 1 on rail 4, thus being clearly illustrated how palletizing is carried out with the machine object of the present invention.

As it has already been mentioned in the beginning of the description of this machine, one of its operative particularities remarkable is its character of self-propelled, which turns it an independent machine regarding energy supplies used. In effect, FIGS. 1-4 show that on cart chassis 3 a pair of batteries 33 are arranged, for example 24 VCC voltage batteries, from which the electrical energy is provided necessary and sufficient to feed motor 13 as well as motor 24 and control unit 5.

Immediately afterwards it will be synthetically explained the general operation of the machine object of the present invention, and other components used not yet detailed will be mentioned.

Once batteries 33 are connected to the power connectors of control unit 5, a type “fungus” switch 34, also used as of emergency shutdown switch is pulled, in order to electrically supply all electrical and electromechanical components incorporated to cart 1. By means of a remote control or a green push-button 35 it is started the automatic operation cycle of the machine, according to the steps that are detailed afterwards:

In order to begin the automatic operation cycle of the machine, previously pallet 31 must be placed in surface “S” and, in addition, the lower end-track switch 18 operatively connected to the scissors type mechanism 6 must be actioned as shown in FIG. 3. At that moment, a built-in acoustic alarm incorporated to the control unit 5 sounds during a second, thus warning of the beginning of the working cycle of the machine. Passed the signal sound, the drive motor 24 is put into operation, beginning to palletize the base of pallet 31. By means of a programmable turns counter, which is included in control unit 5, cart 1 will remain turning around the base of the pallet 31a determinate number of turns ordered by this counter. The number of turns can be visualized in a screen or “display” 36 of the control unit 5. When reached the programmed number of turns around the base of 31, motor 13 is put into operation, elevating coil 3 of the laminal material until the top of pallet 31. Once sensor 26 detects that the top or upper end of pallet 31 has been reached, it starts a timer of delay until the ascending movement of scissors mechanism 6 stops. In case of not being detected the ceiling of 31, for example, due to a fault of sensor 28, the upper end-track switch 20 will make the same action that sensor 28, stopping the ascending movement of coil 3.

Once reached and detected the top of pallet 31, cart 1 remains turning the number of turns previously programmed in the counter of the control unit 5. The number of turns also now can be visualized in screen 36 of the control unit 5. When reached the programmed number of turns, scissors mechanism 6 begins folding, descending therefore coil 3, until being activated the lower end-track switch 18. Being coil 3 in a lower position, cart 1 remains turning until, when locating inductive sensor 29 on the strip of metal 30 fixed to rail 4, it will immediately stop cart displacement, always in the same place. It is possible to emphasize that motors 13 and 24 include a dynamic braking system, helping to stop rapidly at any circumstance that must stop its march.

At any moment during a palletizing process, machine cycle can be stopped or restarted pressing a start push-button on a remote control or from the board of the control unit 5, continuing the cycle from where it was interrupted. The board of the control unit 5 includes two push-buttons, 37 and 38, to manually drive ascending and descending movements of the scissors mechanism 6. When using these commandos operation cycle is automatically reset.

If pallet optical sensor 28 does not detect the existence of said pallet or if the mechanism scissors 6 is not positioned down, machine will be able to turn manually without making the cycle, for which it is enough with driving a starting push-button 39, it will stop with the same command.

When acting the cart stopper optical sensor 28′ by the presence of strange objects in surface “S”, this stops immediately, sounds an acoustic alarm and it is also visualized a legend or a suitable symbol in screen 36 of the control unit 5 that informs about the detected abnormal situation. The turn is restarted by pressing the starting push-button 39.

The control unit 5 includes a operation-hours counter visualized in the screen 36, that serves in addition to know the reminding autonomy before recharging batteries 33. Once the time of autonomy is reached, low level battery will be reported, it will sound an acoustic alarm and it will be displayed a legend or a symbol warning this situation in screen 36 of the control unit 5. This function responds as long as the counter is reset, pressing during 3 seconds the starting push-button 39 after recharging the batteries. This function is just informative and the operation of the machine is not interfered.

It can also be seen time and/or date and operation-hours of the machine in screen 36 of the control unit 5.

If machine will not be used by a prolonged time it is recommendable to push emergency push-button 34, which will apply no tension to the board of the control unit 5 with the object of saving electrical energy of batteries 33.

We claim:

1. Packaging machine, of the type that comprises a self-propelled cart that turns around a set of objects of diverse nature piled up on a platform in order to wrap them up with a laminal material, generally a plastic film, or sheet, surrounding them with several turns by laminal material until conforming a package firmly wrapped up to be afterwards elevated by means of a freight elevator and to be transferred to another location, for example, towards a deposit for its storage or to be loaded in vehicles destined to transport them towards another destiny, including said cart a chassis where elevating members of a roll or coil of laminal material, mounted in a coil-carry support, being the machine characterized because these elevating members of the coil of laminal material are defined by a type scissors mechanism, in one of whose superior arms is mounted in supporting connection said material coil carry support device, including the cart an electronic operation control unit on of the machine remotely commanded.

2. Packaging machine according to claim 1, characterized because said type “scissors” mechanism is formed by a plurality of articulated to each other arms, being fixed to a superior arm of this scissors type mechanism the support device of the coil of laminal material, whereas a first lower arm of the scissors type mechanism is movably connected to drive devices of the ascending-descending movement of said mechanism, whereas a second lower arm of the scissors type mechanism is movably fixed to the chassis of the cart.

3. Packaging machine in according to claim 2, characterized because said drive members are defined by a scissors mechanism driving motor and an endless screw, parallel to the chassis of the cart, which presents a first end portion connected to said motor and said endless screw going through a screwing dice fixed to a lower end portion of this first lower arm of the scissors type mechanism.

4. Packaging machine according to claim 3, characterized because proximate to a second end of the endless screw is arranged on the cart chassis a lower end-track switch to which is operatively connected to said scissors mechanism driving motor, being said end-track switch aligned below a second end portion of the first lower arm of the scissors type mechanism.

5. Packaging machine according to claim 3, characterized because in the proximities of the scissors mechanism driving motor is arranged a upper end-track switch which is operatively connected to said motor.

6. Packaging machine according to claim 1, characterized because in an upper arm of the scissors type mechanism an optical sensor is arranged in order to detect the upper end portion or top of the pallet of set of objects to be packaged.

7. Packaging machine according to claim 1, characterized because it includes a cart deactivation and stop security sensor, which is operative for detecting strange bulks in the space delimited by the annular rail, being said security sensor operatively connected to the electronic operation control unit.

8. Packaging machine according to claim 1, characterized because it includes a cart stopping sensor in a determined point of the rail.

9. Packaging machine according to claim 8, characterized because said cart stopping sensor is an inductive sensor arranged below the cart chassis and is operatively connected to a ferromagnetic strip of metal arranged in a point of the circular track of the cart.

10. Packaging machine according to claim 1, characterized because the cart is mounted in a sliding way on an annular rail that delimits a circular surface.

11. Packaging machine according to claim 10, characterized because the cart includes at least a pair of wheels for assembly said cart with said annular rail and at least one drive wheel connected to a drive motor.

12. Packaging machine according to claim 10, characterized because said annular rail is conformed by sections connectable to each other.

13. Packaging machine according to claim 1, characterized because batteries are arranged in the cart for providing electrical energy to the cart, to the elevation of the scissors type mechanism and to the machine operation control unit.
